(19) United States
(12) Patent Application Publication
(10) Pub. No.: US 2024/0370714 A1
(43) Pub. Date: Nov. 7, 2024

(54) STRUCTURE AWARE TRANSFORMERS FOR NATURAL LANGUAGE PROCESSING

(71) Applicant: MICROSOFT TECHNOLOGY LICENSING, LLC, Redmond, WA (US)

(72) Inventors: Leo Moreno BETTHAUSER, Redmond, WA (US); Muhammed Fatih BULUT, Cambridge, MA (US); Bryan (Ning) XIA, Redmond, WA (US)

(21) Appl. No.: 18/312,243

(22) Filed: May 4, 2023

(51) Int. Cl. G06N 3/0499

(52) U.S. Cl. CPC G06N 3/0499

(57) ABSTRACT

Disclosed is a machine learning model architecture that can incorporate structure information from multiple types of structured text into a single unified machine learning model. For example, a single unified model may be trained with structure information from XML files, tabular data, and/or flat text files. A structure-aware attention mechanism builds on the attention mechanism of the transformer architecture. Specifically, values computed for a traditional transformer attention mechanism are used to compute structure-aware attention scores. In some configurations, the location of a token in the structured text is incorporated into that token's embedding. Similarly, metadata about a token, such as whether the token is a key or a value of a key/value pair, may be incorporated into the token's embedding. This enables the model to reason over token metadata and the location of the token in the structured text in addition to the meaning of the token itself.

### BACKGROUND

Transformers are a groundbreaking neural network architecture for machine learning tasks such as natural language processing (NLP). Transformers feature a self-attention mechanism that learns which parts of the input sequence to pay attention to. This allows the model to learn complex relationships and dependencies between tokens. For example, when translating a sentence from one language to another, tokens are the words of the sentence. The self-attention mechanism learns which words of the sentence are important—and as such should be paid attention to.

Transformers have become the foundation for many state-of-the-art NLP models, such as BERT, GPT, RoBERTa, and more. They have demonstrated significant improvements in various tasks, including machine translation, sentiment analysis, question-answering, and text summarization.

Transformers, as originally conceived, processes a flat sequence of tokens, such as words of an essay. However, text is often found in structured formats, such as eXtensible Markup Language (XML), JavaScript Object Notation (JSON), table-based formats, etc. The structure of the text may provide valuable information about the meaning of the text. When structured text is processed as if it were a flat text file information related to this structure may be lost. As a result, the model may be less accurate, or the model may require more computing power and/or more training to compensate.

Attempts have been made to modify transformer architecture to accommodate learning from various formats of structured text. Nonetheless, these approaches are tailored to a specific kind of structured text, hindering the ability to train a single unified model on diverse text types. This constraint not only imposes increased training expenses, as multiple models are needed to assimilate structural information from different structured text forms, but also results in additional hosting costs associated with maintaining multiple models.

It is with respect to these and other considerations that the disclosure made herein is presented.

### SUMMARY

Disclosed is a machine learning model architecture that can incorporate structure information from multiple types of structured text into a single unified machine learning model. For example, a single unified model may be trained with structure information from XML files, tabular data, and/or flat text files. A structure-aware attention mechanism builds on the attention mechanism of the transformer architecture. Specifically, values computed for a traditional transformer attention mechanism are used to compute structure-aware attention scores. In some configurations, the location of a token in the structured text is incorporated into that token's embedding. Similarly, metadata about a token, such as whether the token is a key or a value of a key/value pair, may be incorporated into the token's embedding. This enables the model to reason over token metadata and the location of the token in the structured text in addition to the meaning of the token itself.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates a traditional transformer architecture for building a machine learning model.

FIG. 2 illustrates a self-attention module computing an attention score matrix.

FIG. 3 illustrates using an attention score matrix to compute a hidden representation of a model input.

FIG. 4 illustrates encoding token location and token metadata.

FIG. 5 illustrates structured masked-language modeling for pre-training token embeddings from structured text.

FIG. 6 illustrates a structure-aware transformer architecture that builds on a traditional transformer architecture.

FIG. 7 illustrates computing a structure-aware attention weight for two tokens located within hierarchical text.

FIG. 8 is a flow diagram of an example method for structure-aware transformers for natural language processing.

FIG. 9 is a computer architecture diagram illustrating an illustrative computer hardware and software architecture for a computing system capable of implementing aspects of the techniques and technologies presented herein.

FIG. 10 is a diagram illustrating a distributed computing environment capable of implementing aspects of the techniques and technologies presented herein.

### DETAILED DESCRIPTION

The original transformer architecture for training large language models (LLMs) fails to incorporate structure information. Failing to incorporate structure information results in a model that is less accurate than a model that does. As referred to herein, structure may refer to a hierarchy, table, or other data format that imposes rules on how text may be represented. Structured text is often associated with a grammar that defines these rules.

One example of structure information is the location of a token within hierarchical text, such as JSON. For example, structure information may indicate which branch of the hierarchy a token is on and the depth of the token on that branch.

Another example of structure information is token metadata—some information about the token beyond the actual value of the token. Examples of token metadata include a data type associated with the token, whether the token is a keyword, a role the token plays within the structure, etc. For example, metadata may indicate that a token is a value of a key-value pair.

Other types of structure and other types of metadata are similarly contemplated. Furthermore, while this disclosure uses structured text as an example, other types of structured data including images, vector graphics, binary data, and the like are similarly contemplated.

One existing technique for consuming structured data is to flatten the data and present the flattened data to a traditional transformer as any other flat text input. However, flattening leads to the loss of valuable information such as hierarchies and the relationships between columns and values in a table. As a result, the structure of the original text becomes obscured, reduced into a mere sequence of words.

Other existing techniques for consuming structured data work on a particular type of structured data to the exclusion of other types of structured data. For example, one existing technique incorporates row and column information when training a machine learning model on table-based data. However, this same technique is unable to process hierarchical data.

In order to overcome these deficiencies, the claimed embodiments enhance the transformer architecture to incorporate structure information when training a machine learning model. This structure-aware transformer architecture is multi-modal in that it works on different structures. Flat text may also be processed by interpreting it as a hierarchy with a single branch. Additionally, or alternatively, the structure-aware transformer architecture may incorporate metadata when training a model, such as whether a token is a key of a key-value pair.

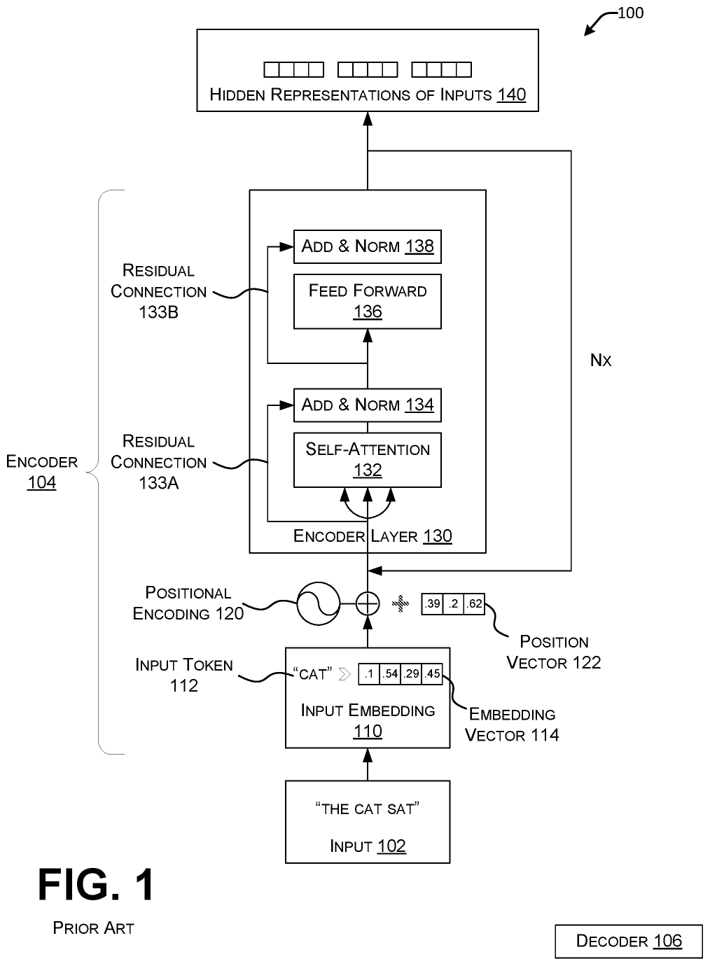

FIG. 1 illustrates a Transformer architecture 100 for building a machine learning model. A Transformer is a neural network architecture that was introduced in the paper “Attention is All You Need” by Vaswani et al. (2017). It is a type of sequence-to-sequence model that has achieved state-of-the-art results on a variety of natural language processing (NLP) tasks, including machine translation, text summarization, and question answering.

A Transformer consists of an encoder 104 and/or a decoder 106. Encoders and decoders are typically composed of multiple layers of self-attention and feedforward neural networks. Encoder 104 processes tokens from input sequence 102 one at a time—although multiple encoders may process tokens of input 102 in parallel. Each token is processed by a series of stacked encoding layers 130—the output of one encoding layer 130 being consumed as input to the next encoding layer 130. The last encoding layer 130 to process a token yields a hidden representation 140 for that token. Hidden representation 140 may also be referred to as a context vector.

Encoder 104 may process input 102 while training the model or when using the model for inference. Input 102 is typically a string of characters. Flat text input 102 is tokenized—split into individual words—before further processing. For example, “the cat sat” may be tokenized into “the”, “cat”, and “sat”. Each token is processed in turn by the remainder of encoder 104.

Input embedding module 110 obtains an embedding vector 114 for input token 112. Embedding vector 114 is a numerical representation that captures the meaning of input token 112. Word embeddings are typically generated through unsupervised pre-training on large text corpora using techniques like Word2Vec, GloVe, or FastText. Words that appear in similar contexts or have similar meanings have embedding vectors that are closer to each other than unrelated words. “Closer” in this context may refer to a Euclidian distance, but other measures of closeness are also contemplated.

Positional encoding module 120 encodes the position of input token 112 as it appears in the input sequence 102. Positional encoding allows the model to account for word order and relationships between words based on their positions in the sequence. In some configurations, positional encoding module 120 adds position vector 122 to embedding vector 114. Position vector 122 may, for example, be concatenated with embedding vector 114.

Encoding layer 130 uses token embeddings, including position embeddings, to generate query, key, and value vectors. Query, key, and value vectors are generated by applying separate learned linear transformations to the position-aware token embeddings.

A query vector represents the current token in the input sequence. It is used to “query” the other tokens in the sequence to determine their relevance to the current position.

Key vectors represent the other tokens in the input sequence. The relevance of the current token to another token in the sequence may be computed by performing a dot product between the query vector and the other token's key vector.

Value vectors represent the same elements as key vectors in the input sequence, but they encode information that will be used by self-attention module 132 to generate the output of the model. Specifically, once query and key vectors have been used to compute attention weights, indicating which tokens in the sequence are most relevant to the current token, self-attention module 132 applies the attention weights to the value vectors. Feed-forward network 136 processes the result of applying attention weights to value vectors, yielding hidden representation 140.

Self-attention module 132, in connection with feed forward network 136, encodes the input sequence 102 into a sequence of hidden representations 140. In architectures with an encoder 104 and a decoder 106 the hidden representation 140 is passed to decoder 106. In decoder 106, Self-attention module 132 is used to select which of the encoder's hidden representations 140 to use when generating an output sequence. In some configurations, encoder 104 is used without decoder 106 to index documents, query for related content, and perform other search-like tasks.

One example of a problem that self-attention may be used to solve is coreference resolution, such as relating a noun and a pronoun in a sentence. Consider the text “Jane works as a software engineer. She loves her job.” The pronouns “She” and “her” both refer to the noun “Jane.” During training, self-attention module 132 learns to make these associations.

Self-attention module 132 computes attention scores between all pairs of tokens. The attention scores reflect the relevance or importance of one token to another. Continuing the example, when processing the pronoun “She,” the self-attention mechanism will likely assign a high attention score to the noun “Jane” because it is semantically related. Similarly, for the pronoun “her,” the model will also assign high attention scores to both “Jane” and “job”. This captures the relationship between the pronoun and the noun it refers to, as well as the noun representing the object it describes.

Residual connections 133 pass the embedding vectors of input 102 to subsequent iterations of encoder layer 130. This enables the subsequent iterations access to the original embeddings as well as any information derived from previous iterations of encoder layer 130.

Add and normalize modules 134 and 138 combine the embedding vectors of input 102 as provided by residual connections 133 with the output of self-attention module 132 and feed forward module 136, respectively. Add and normalize modules 134 and 138 also normalize the output values of self-attention module 132 and feed forward module 136, respectively. Normalizing these outputs stabilizes the training process.

Self-attention module 132 may be a multi-headed attention module, which duplicates the self-attention mechanism in order to learn different types of relationships between the tokens of input 102. Each attention head processes the same token, but in different ways, and as such can learn to focus on different patterns, relationships, or dependencies between words. This allows the model to capture a more diverse and nuanced understanding of the input sequence. Self-attention module 132 concatenates the results of each individual attention head.

As discussed briefly above, feed forward module 136 processes and combines the outputs of the multi-head attention mechanism provided by self-attention module 132, as well as any information provided by residual connection 133. This adds more complexity and expressive power to the model. Feed forward module 136 may be a two-layer fully connected neural network.

In some configurations, multiple encoder layers 130 are applied in series. Each encoder layer 130 produces a hidden representation 140, which is provided as input to the next encoder layer 130. Once the final iteration of encoder layer 130 is applied, a final hidden representation 140 is generated.

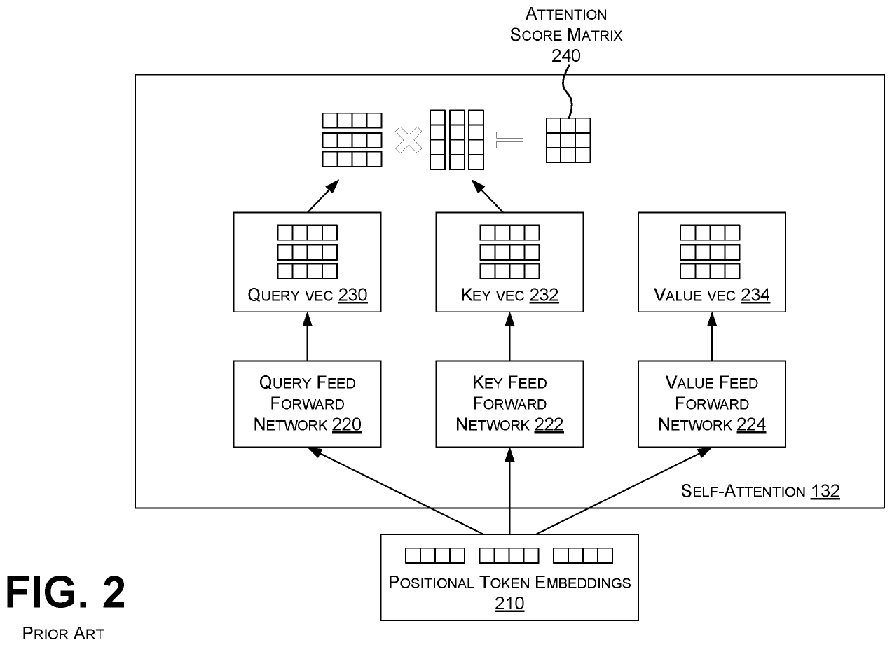

FIG. 2 illustrates self-attention module 132 computing attention score matrix 240. Positional token embeddings 210 are token embeddings like embedding vector 114 that have been augmented with position vector 122. Query feed forward network 220, key feed forward network 222, and value feed forward network 224 generate query vectors 230, key vectors 232, and value vectors 234 from the positional token embeddings 210. During training, the weights of feed forward networks 220, 222, and 224 are updated according to techniques of reinforcement learning.

Self-attention module 132 computes attention score matrix 240 by matrix multiplication of query vector 230 and key vector 232. Specifically, for each pair of tokens of input 102, a dot product is computed between the query vector 230 and key vector 232. Attention score matrix 240 contains the results of each of these dot products.

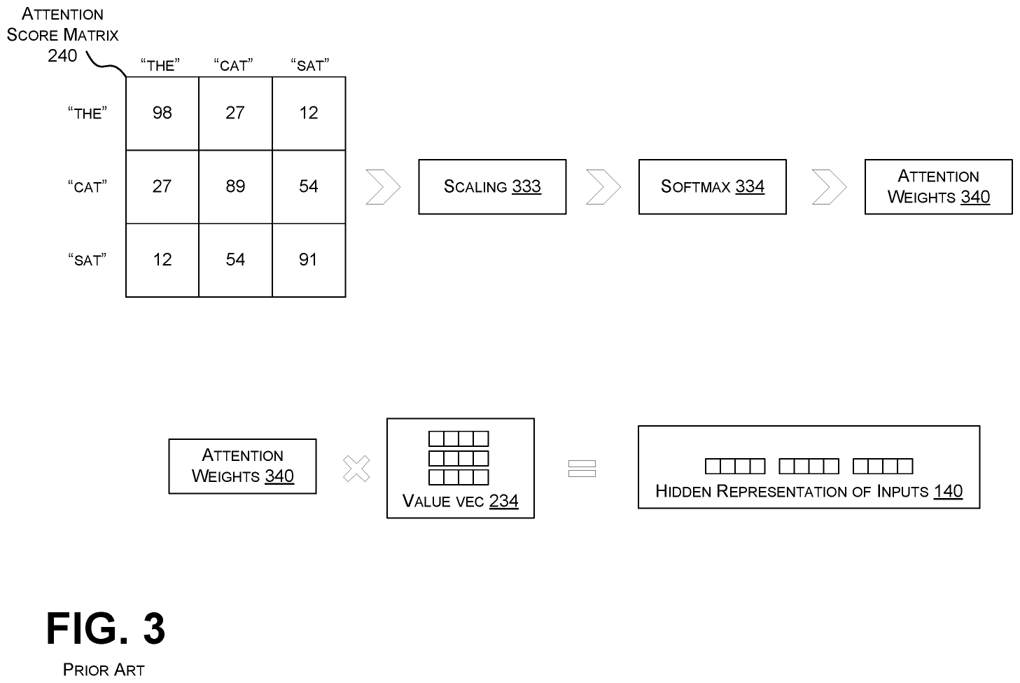

FIG. 3 illustrates using attention score matrix 240 to compute hidden representations 140 of tokens 112 from model input 102. Scaling module 333 scales the values of attention score matrix 240. This has the effect of smoothing the scores, as very large dot products can result in steep gradients during backpropagation. In some configurations, attention scores are scaled by dividing them each by the square root of the dimension of key vector 232. For example, if key vector 232 has 1024 dimensions, then each element of attention score matrix 240 is divided by 32.

Softmax module 334 then converts the scaled attention scores to a probability distribution that sums to 1. This normalizes the attention scores, ensuring that the scores are in a suitable range and helps the model focus on the most relevant tokens. Once attention weights 340 have been computed, they are multiplied by value vectors 234 to produce hidden representation of inputs 140.

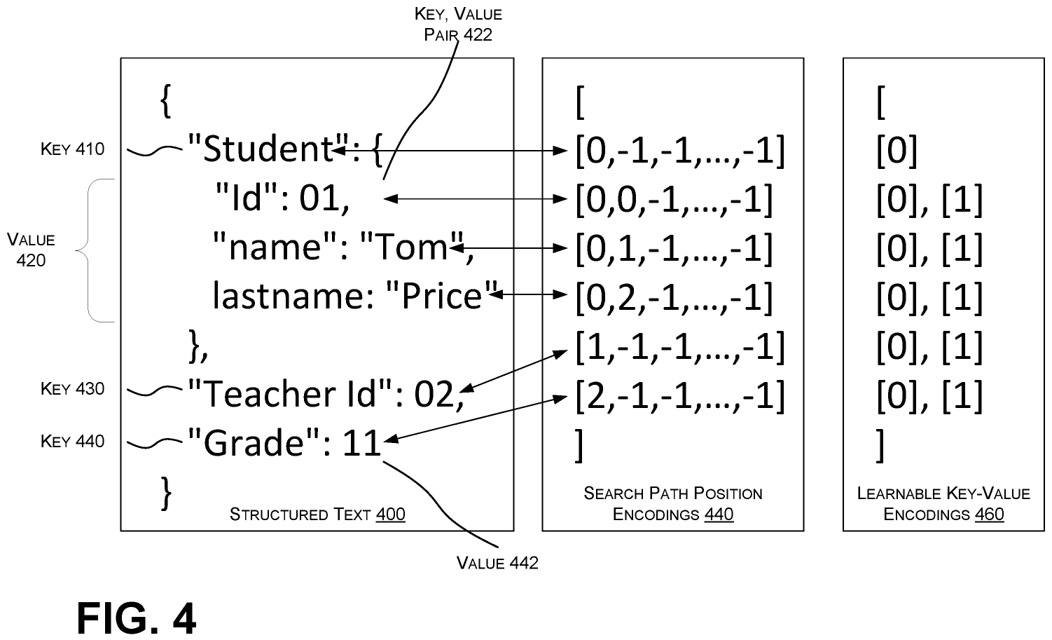

FIG. 4 illustrates encoding token location and token metadata. Existing techniques for positional encoding, such as sinusoidal functions, locate a token within a flat text file. If hierarchical text is flattened before being processed by encoder 104, positional encoding module 120 would identify the location of each token within the flattened text, failing to encode the locations of tokens within the hierarchy.

Structured text 400 has a hierarchy—“Student” key 410, “Teacher Id” key 430, and “Grade” key 440 are root level elements in the hierarchy. The hierarchy is expressed using key-value pairs where a complex value may contain a list of sub-keys. As illustrated, value 420 is a complex value that includes keys named “Id”, “name”, and “lastname.” The key “Id” and associated value 01 constitutes a key, value pair 422.

Search path position encodings 440 encode the location of each key within the hierarchy. Each key in the hierarchy is associated with a vector of offsets. The order of the search path position encoding vectors matches the order in which keys are encountered when traversing the hierarchy, e.g. via a breadth-first search. Each offset indicates a location of that key relative to it's parent. The number ‘−1’ is a null value, indicating that there is no key associated with that position in the vector.

For example, key 410 (“Student”) is located in the hierarchy by the vector [0, −1, −1, . . . , −1]. Only the first number, ‘0’, locates the key in the hierarchy. Specifically, it indicates that key 410 is located at offset ‘0’ from the root of the hierarchy.

Similarly, the location of the key “name” is represented by the vector [0, 1, —1, . . . , −1]. The ‘0’ indicates that “name” is part of the branch that begins at offset ‘0’ from the root of the hierarchy. The ‘1’ indicates that “name” is part of the branch that begins at offset ‘1’ off the “Student” branch.

The ‘−1’ in the search path position encoding vector means that location of the “name” key has been found, and that no further location information is warranted. In some configurations, the offset of the first ‘−1’ in a hierarchical position vector indicates the depth of the key along the indicated branch. For example, the first ‘−1’ of the “name” key is at index ‘2’ (with the first entry having the index of zero), indicating that the “name” key is at a depth of ‘2’ in the hierarchy.

Learnable key-value encodings 460 is a table that indicates whether a token in structured text 400 is key or a value. This is an example of metadata that can be obtained from structured text and which allows the model to reason over more than just the semantics of the tokens themselves. As illustrated, a value of [0] indicates that a token is a key, while a value of [1] indicates that a token is a value. Entries in learnable key-value encoding vector 460 appear in the same search order as search path position encodings 440—an order that is obtained by traversing the tokens of structured text 400, e.g., by depth-first or breadth-first search. Other types of metadata are similarly contemplated.

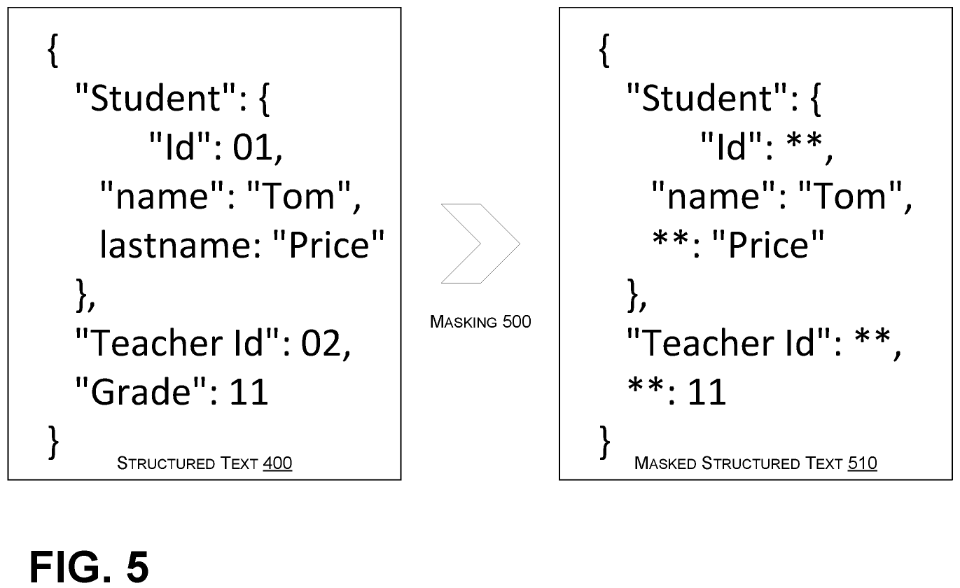

FIG. 5 illustrates structured masked-language modeling for pre-training token embeddings from structured text. Masked language modeling as applied to flat text is a pre-training objective that helps models learn contextual representations of words and their relationships with surrounding words in a sentence. It is commonly used in self-supervised learning, where training data is created from the input text without the need for explicit human-annotated labels.

In masked language modeling, a percentage of the input tokens are randomly masked. For example, the input tokens may be replaced with a special [MASK] token, although other masking techniques exist. The goal of the model is to predict the original tokens from the context provided by the remaining unmasked tokens. For example, consider the sentence: “The cat sat on the mat.” During pre-training, the sentence might be transformed into: “The cat [MASK] on the mat.” The model's objective would then be to predict the masked token “sat” based on the context given by the other tokens in the sentence.

Structured masked-language modeling extends this idea to structured text. Since more is known about structured text it is possible to strategically limit the tokens that may be masked. For example, in JSON, a curly brace token may be omitted because it is known to define the structure of the hierarchy and so it likely does not have significant semantic meaning. Additionally, or alternatively, tokens that are known to be values of a key-value pair may be preferentially selected to be masked.

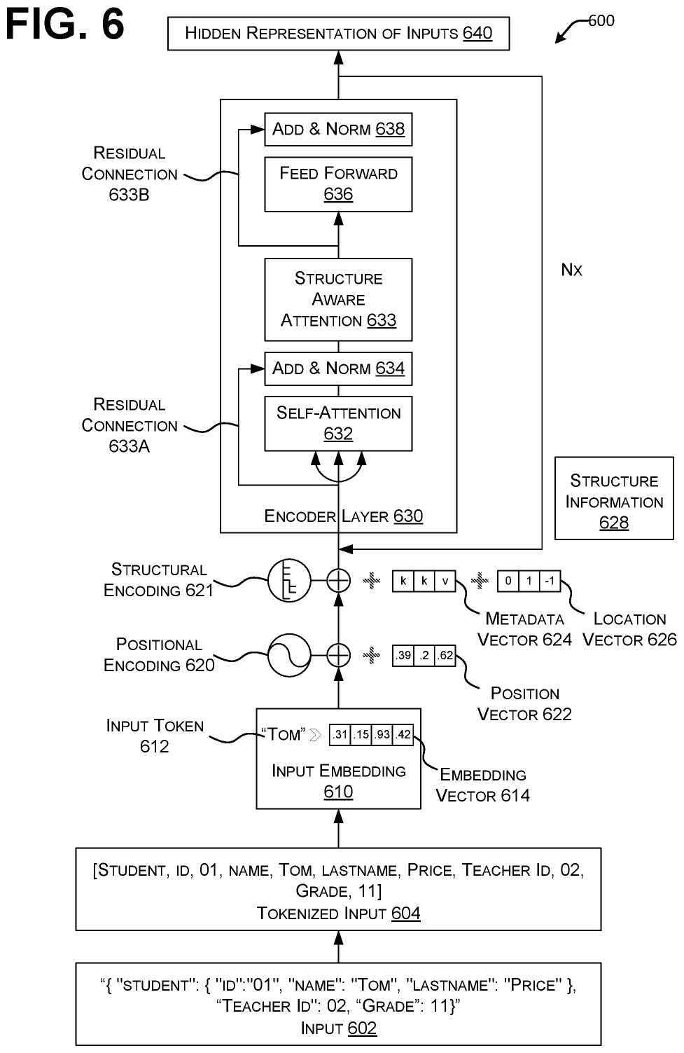

FIG. 6 illustrates a structure-aware transformer architecture that builds on a traditional transformer architecture. Specifically, the structure aware transformer architecture includes structural encoding module 621 and structure-aware attention module 633.

First, input 602 is processed into tokenized input 604, such as by flattening hierarchical input text 602 into a sequence of tokens that can be processed by self-attention module 632. Input embedding module 610 and positional encoding module 620 process tokenized input 604. For example, input embedding module 610 processes input token 612 (“Tom”) to obtain embedding vector 614. Positional encoding module 620 processes embedding vector 614 to generate position vector 622.

Structural encoding module 621 parses input 602 to identify structure information 628, such as a hierarchy of an XML file or the columns and rows of a data table. Structural encoding module 621 may also identify the location of each token within the structure, encoding this information in location vector 626.

In some configurations, structural encoding module 621 identifies metadata pertaining to individual tokens, such as whether a token is part of a key-value pair or whether a token is a column label. This metadata is encoded in metadata vector 624.

Structural encoding module 621 may then augment embedding vector 614 to include location vector 626 and/or metadata vector 624. Location vector 626 and metadata vector 624 may be added to embedding vector 614 in addition to position vector 622. This gives the model the opportunity to reason over token location within the structure and/or metadata in addition to the meaning of the token.

Structure-aware attention module 633 leverages computations performed by self-attention module 632 to compute structure-aware attention scores. Specifically, self-attention module 632 computes a matrix M of attention weights, one for each pair of tokens in sequence 602. Each of these position-based attention weights is computed with a matrix multiplication—a relatively expensive computing operation. This matrix M may be described mathematically as:

$$M ( {s}_{x} , {s}_{y} ) := \frac{( {s}_{x , token} ⊕ {s}_{x , type} ) \cdot ( {s}_{y , token} ⊕ {s}_{y , type} )}{‖ {s}_{x , token} ⊕ {s}_{x , type} ‖ ‖ {s}_{y , token} ⊕ {s}_{y , type} ‖}$$

Where sₓ and s_{y} are tokens of tokenized input 604. This mathematical expression represents the cosine similarity between two combined vectors, where each combined vector is formed by the direct sum (⊕, circled plus) of a token vector (s_{x,token} or s_{y,token}) and a type vector (s_{x,type} or s_{y,type}). The denominator, ∥s_{x,token}⊕s_{x,type}∥∥s_{y,token}⊕s_{y,type}∥, multiplies the L2 norms (Euclidian norms) of each combined vector. The L2 norm is the square root of the sum of the squared components of a vector. The higher the cosine similarity, the more similar the two combined vectors are.

In some configurations, structure aware attention module 633 leverages attention weights of matrix M to compute similarity values between pairs tokens. In the case of hierarchical text, each token is located along a branch of the hierarchy. For a token sₓ, the sequence of tokens which constitute the depth-first search path containing the input token is defined as:

$$P ( {s}_{x} ) := ( {s}_{i} , {s}_{j} , … , {s}_{k} )$$

Then, the attention similarity value between two input sequence tokens is defined as:

$$A ( {s}_{x} , {s}_{y} ) := \frac{M ( P ( {s}_{x} ) \times P ( {s}_{y} ) )}{\vert P ( {s}_{x} ) \times P ( {s}_{y} ) \vert} = \frac{1}{\vert P ( {s}_{x} ) \vert \vert P ( {s}_{y} ) \vert} {\sum }_{{s}_{0} ∈ P ( {s}_{x} )} {\sum }_{{s}_{1} ∈ P ( {s}_{y} )} M ( {s}_{0} , {s}_{1} )$$

In this equation, A(sₓ, s_{y}) refers to the attention weight of tokens sₓ and sₓ.

$$\frac{M ( P ( {s}_{x} ) \times P ( {s}_{y} ) )}{\vert P ( {s}_{x} ) \times P ( {s}_{y} ) \vert}$$

is the average value of the traditional attention weights of the cartesian product of P(sₓ) and P(s_{y}). P(sₓ) and P(s_{y}) represent sets of tokens on the branches to nodes sₓ and s_{y}. Their cartesian product is generated by, for each token along one of the branches, pairing it with each of the tokens along the other branch.

$$\frac{1}{\vert P ( {s}_{x} ) \vert \vert P ( {s}_{y} ) \vert} {\sum }_{{s}_{0} ∈ P ( {s}_{x} )} {\sum }_{{s}_{1} ∈ P ( {s}_{y} )} M ( {s}_{0} , {s}_{1} )$$

refers to a normalized sum of position-based attention weights M(s₀, s₁) over all pairs of elements (s₀, s₁). As above, P(sₓ) and P(s_{y}) represent sets of tokens on the branches to nodes sₓ and s_{y}. |P(sₓ)| and |P(s_{y})| represent the cardinalities (sizes) of the sets P(sₓ) and P(s_{y}), respectively. s₀∈P(sₓ) and s₁∈P(s_{y}) indicate that s₀ and s₁ are elements of P(sₓ) and P(s_{y}), respectively. Together, the nested summations yield the sum of all pairs of elements (s₀, s₁) from the two branches.

This technique for computing structure-aware attention weights is illustrated by the example of FIG. 6. Input 602 contains the text “{“student”: {“id”:“01”, “name”: “Tom”, “lastname”: “Price” }, “Teacher Id”: 02, “Grade”: 11}.” After being tokenized as tokenized input 604 (“[Student, id, 01, name, Tom, lastname, Price, Teacher Id, 02, Grade, 11]”), input tokens are processed one at a time.

As illustrated, input token 612, “Tom”, is mapped to embedding vector 614. Positional encoding module 620 may then determine a position vector 622 based on the location of input token 612 in tokenized input 604.

Structural encoding module 621 locates input token 612 within the structure of tokenized input 604. In this example input 602 is a hierarchy, and so structural encoding module 621 encodes the branch and depth of input token 612 in location vector 626. As illustrated, location vector 626 includes a series of offsets that collectively define which branch of the hierarchy input token 612 is from. In this example, location vector 626 is ‘0’, ‘1’, ‘−1’, which indicates that input token 612 is found as the second sub-branch (the ‘1’) of the first root branch (the ‘0’). Structural encoding module 621 also may generate metadata vector 624, which indicates whether input token 612 is a key or a value of a key, value pair, or other metadata. Structural encoding module 621 integrates metadata vector 624 and/or location vector 626 into embedding vector 614.

Structure aware attention module 633 uses the matrix M of attention weights to compute structure-aware attentions, as described above. Encoder layer 630 may be processed a number of times, each iteration accepting as input the hidden representation 640 provided by the previous iteration. The original input tokens may also be made available to each iteration of encoder layer 630. The final iteration of encoder layer 630 produces a final hidden representation of inputs 640, which may be used to index tokens, search for tokens, or perform other look-up tasks. In some configurations, hidden representation 640 may be used by a decoder component to infer structured text from a sequence of tokens.

While hierarchical text is illustrated in FIG. 6, table-based text and flat text are also compatible with the same structure-aware transformer architecture. This allows text input with different types of structures to be used to train the same model, increasing flexibility and efficiencies while leveraging structure information.

A flat text file may be interpreted as a hierarchical text file with a single branch of all keys. The depth of the branch is equal to the number of tokens in the flat text file. The first word of the flat text file is interpreted as the root word, while the second word of the flat text file is interpreted as a child of the root word. For example, the flat text “The quick fox jumped over the lazy dog” may be converted to the following hierarchical representation:

```
{
“The”: {
  “quick”: {
    ...
      “dog”: Null
    }
  }
}
```

Tabular data can also be interpreted as a special case of a hierarchical text file. For example, columns may be mapped to key names and cell values may be mapped to values of a key-value pair. Attention between two tokens is computed using token concatenation columnₖ+v_{i,k} and columnₗ+v_{j,l} without the need for multiple concatenations. A table with three columns “c0”, “c1”, and “c2”, where each column has three rows, may be represented in hierarchical form as:

[
{c0: v_{0,0}, c1: v_{0,1}, c2: v_{0,2}}
{c0: v_{1,0}, c1: v_{1,1}, c2: v_{1,2}}
{c0: v_{2,0}, c1: v_{2,1}, c2: v_{2,2}}
]

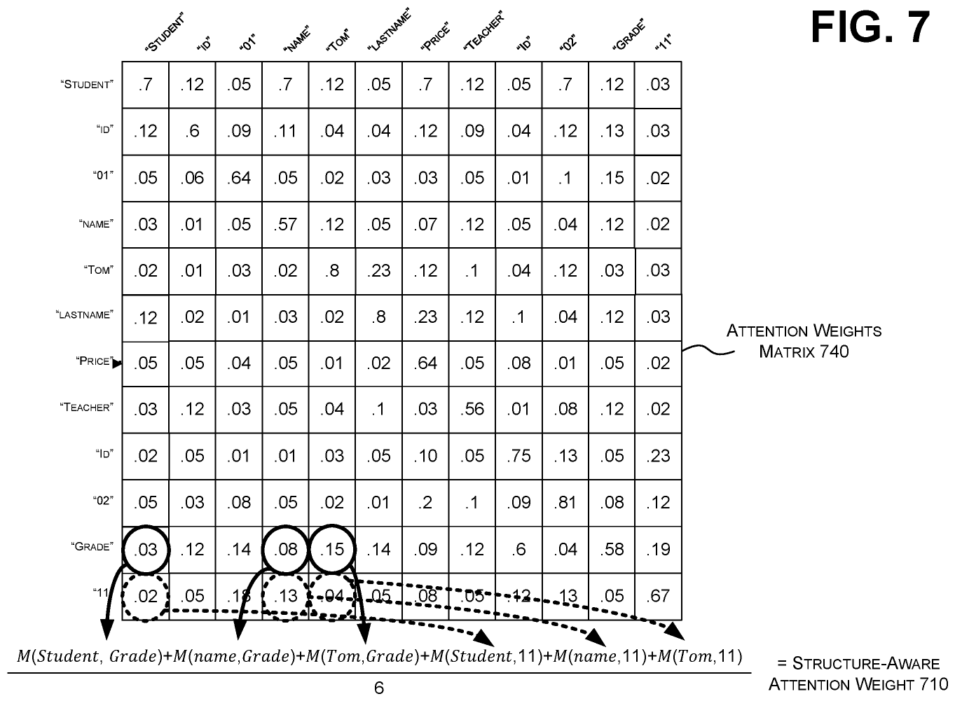

FIG. 7 illustrates computing a structure-aware attention weight for two tokens located within hierarchical text. Continuing the example discussed above in conjunction with FIG. 6, illustrated is an equation for computing the structure-aware attention of two tokens: “Tom” and “11”. The “Tom” token is located along a path P(“Tom”) in the hierarchy of “Student”->“name”->“Tom.” The “11” token is located along a path P(“11”) of “Grade”->“11”. Attention weights matrix 740 contains weights for each pair of input tokens. These weights are the weights computed by a traditional self-attention module 132. Attention weights for each pair of tokens taken from paths “Student”->“name”->“Tom” and “Grade”->“11” are summed—i.e., the weights of the cartesian product of the tokens of the two paths are summed. Specifically, attention weights for token pairs “Student” and “Grade”, “name” and “Grade”, and “Tom” and “Grade” are summed together with attention weights for token pairs “Student” and “11”, “name” and “11”, and “Tom” and “11”. The resulting sum is divided by “6”—the total number of attention weights that were summed.

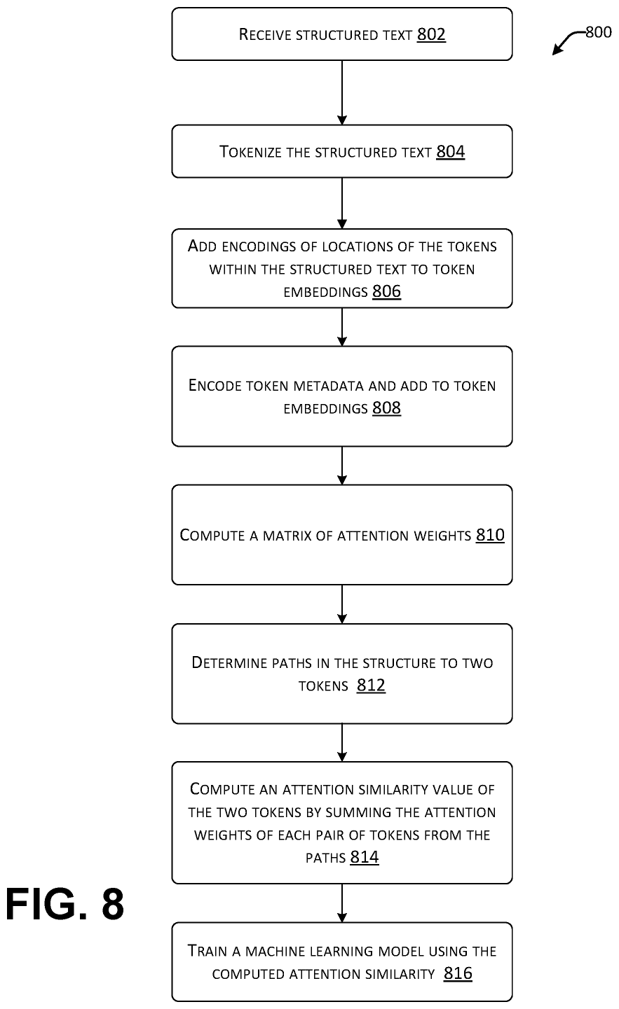

With reference to FIG. 8, routine 800 begins at operation 802, where structured text is received (e.g., structured text 602). Structured text may be hierarchical, such as XML or JSON. Structured text may also be flat text or text that contains tabular data. Flat text or tabular data may be first pre-processed into a hierarchical format as discussed above in conjunction with FIG. 6.

One example of structured text is a log file generated by an operating system. Log files may provide information about hardware and software events that occur on a computing device. For example, when a user logs into the computing device, the operating system may emit a log line entry named “login attempt”. The log line may include the date and time of the login, an indication that the log line originated from the operating system, an identity of the user account, whether the login attempt was successful, and other event specific details. Log file entries may similarly be emitted when an application opens a file, communicates over a network, performs an operation that requires administrative privileges, etc. In one example embodiment, log files are analyzed to identify anomalous activity on the computing device. Other embodiments may be used to diagnose application crashes, performance issues, etc.

Log files may be structured in that each log line is one node in a structured document format, such as XML or JSON. Each log line may have child nodes, such as the date and time, the user account, or any other event-specific data. These child nodes may themselves have child nodes. For example, the user account may be defined with a username and a domain name, and so the user account node may be represented as an element with two child nodes—one for the username and one for the domain name. Similarly, a log line that stores an indication of network access, such as navigating to a web page, may represent an IP address and a port as distinct sub-nodes.

In some configurations, log lines themselves may be nested. For example, an event that represents logging in to the computing device may trigger authentication verification events, file access permission checks, and the like. Events representing these nested events may be emitted as sub-nodes of the login node.

Next at operation 804, the structured text is tokenized. Tokenization may identify a sequence of tokens from within the structured text by traversing the hierarchy. At the same time, tokenization may distinguish meaningful tokens from punctuation that defines the hierarchy. Continuing the example of applying a security anomaly analysis to the log file, if the log file is an XML file, then angle brackets may be used to delineate elements during tokenization.

Next at operation 806, encodings 626 of locations of the tokens 612 within the structured text 602 are added to token embeddings 614. Continuing the example of applying a security anomaly analysis to the log file, the location of the “login attempt” node within the structure of the log file may be determined. Any sub-nodes of the “login attempt” node may also be identified. These locations may be encoded by a series of offsets from the root node of the log file. These offsets indicate where each node exists in the structure relative to the root node of the log file.

Next at operation 808, metadata encodings 624 and/or location vectors 626 associated with tokens 612 are concatenated or otherwise combined with token embeddings 614. Continuing the example of applying a security anomaly analysis to the log file, the word “login” of a login attempt event is converted into an embedding vector. Additionally, location vector 626 encodes the location of the word “login” in the structure of the log file. These vectors may be concatenated or otherwise combined, and the result is provided to encoder 630.

Next at operation 810, a matrix of attention weights 740 is computed. As discussed above in conjunction with FIGS. 3 and 7, attention weights are computed using the concatenations of token embeddings 614 and metadata encodings 624 and/or location vectors 626.

Next at operation 812, in order to compute a structure-aware attention between two tokens, paths within the structure to each of the tokens are identified.

Next at operation 814, an attention similarity value of the two tokens is computed by summing the attention weights of each pair of tokens from the identified paths.

Then, at operation 816, a machine learning model is trained using the computed attention similarity. Continuing the example of applying a security anomaly analysis to the log file, the model may be trained with a corpus of log files. Some of the log files have been labeled as containing security anomalies and some have not. For example, log files may be presented in which multiple login attempts were made too quickly to have been performed by a human user, suggesting anomalous use. The resulting machine learning model may learn to recognize the anomalous activity based in part of the relative locations of nodes in the log files that were labeled as containing an anomaly. The trained model may then be used to identify security anomalies in log files that were not part of the training set.

The machine learning architecture disclosed herein may be applied in a number of domains. In addition to performing a security anomaly analysis of log files, structure-aware machine learning models may be trained for use with a chatbot, analyzing financial data, internet search indexing, or any other scenario in which a model may be trained on structured text or a combination of different types of structured text.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 800 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 800 may be also implemented in many other ways. For example, the routine 800 may be implemented, at least in part, by a processor of another remote computer or a local circuit. In addition, one or more of the operations of the routine 800 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

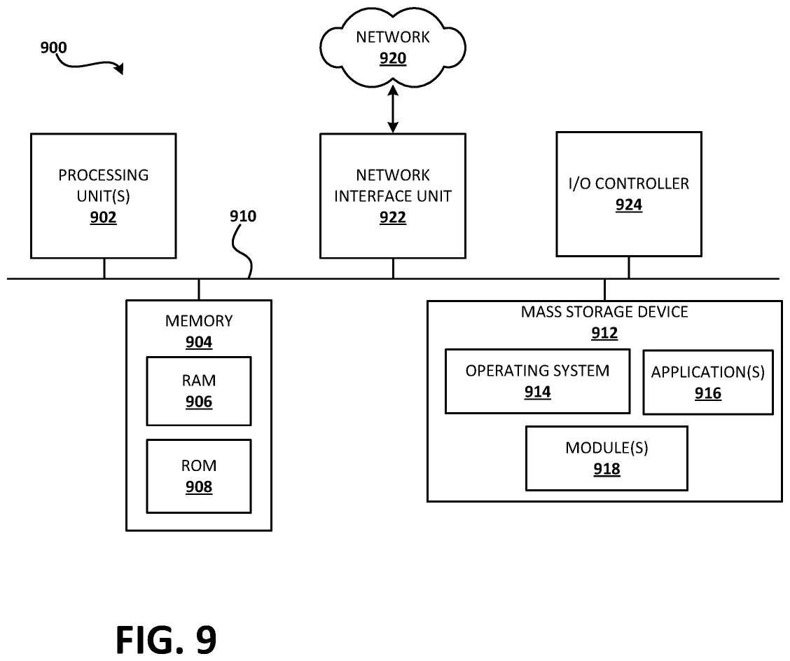

FIG. 9 shows additional details of an example computer architecture 900 for a device, such as a computer or a server configured as part of the systems described herein, capable of executing computer instructions (e.g., a module or a program component described herein). The computer architecture 900 illustrated in FIG. 9 includes processing unit(s) 902, a system memory 904, including a random-access memory 906 (“RAM”) and a read-only memory (“ROM”) 908, and a system bus 910 that couples the memory 904 to the processing unit(s) 902.

Processing unit(s), such as processing unit(s) 902, can represent, for example, a CPU-type processing unit, a GPU-type processing unit, a field-programmable gate array (FPGA), another class of digital signal processor (DSP), a neural processing unit, or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 900, such as during startup, is stored in the ROM 908. The computer architecture 900 further includes a mass storage device 912 for storing an operating system 914, application(s) 916, modules 918, and other data described herein.

The mass storage device 912 is connected to processing unit(s) 902 through a mass storage controller connected to the bus 910. The mass storage device 912 and its associated computer-readable media provide non-volatile storage for the computer architecture 900. Although the description of computer-readable media contained herein refers to a mass storage device, it should be appreciated by those skilled in the art that computer-readable media can be any available computer-readable storage media or communication media that can be accessed by the computer architecture 900.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 900 may operate in a networked environment using logical connections to remote computers through the network 920. The computer architecture 900 may connect to the network 920 through a network interface unit 922 connected to the bus 910. The computer architecture 900 also may include an input/output controller 924 for receiving and processing input from a number of other devices, including a keyboard, mouse, touch, or electronic stylus or pen. Similarly, the input/output controller 924 may provide output to a display screen, a printer, or other type of output device.

It should be appreciated that the software components described herein may, when loaded into the processing unit(s) 902 and executed, transform the processing unit(s) 902 and the overall computer architecture 900 from a general-purpose computing system into a special-purpose computing system customized to facilitate the functionality presented herein. The processing unit(s) 902 may be constructed from any number of transistors or other discrete circuit elements, which may individually or collectively assume any number of states. More specifically, the processing unit(s) 902 may operate as a finite-state machine, in response to executable instructions contained within the software modules disclosed herein. These computer-executable instructions may transform the processing unit(s) 902 by specifying how the processing unit(s) 902 transition between states, thereby transforming the transistors or other discrete hardware elements constituting the processing unit(s) 902.

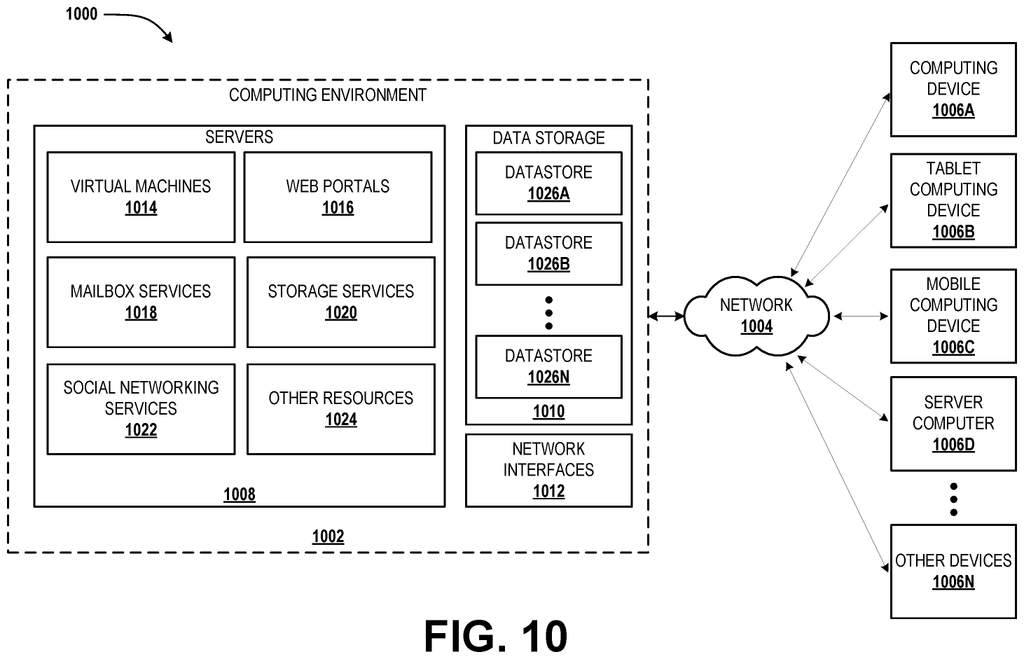

FIG. 10 depicts an illustrative distributed computing environment 1000 capable of executing the software components described herein. Thus, the distributed computing environment 1000 illustrated in FIG. 10 can be utilized to execute any aspects of the software components presented herein. For example, the distributed computing environment 1000 can be utilized to execute aspects of the software components described herein.

Accordingly, the distributed computing environment 1000 can include a computing environment 1002 operating on, in communication with, or as part of the network 1004. The network 1004 can include various access networks. One or more client devices 1006A-806N (hereinafter referred to collectively and/or generically as “clients 1006” and also referred to herein as computing devices 1006) can communicate with the computing environment 1002 via the network 1004. In one illustrated configuration, the clients 1006 include a computing device 1006A such as a laptop computer, a desktop computer, or other computing device; a slate or tablet computing device (“tablet computing device”) 1006B; a mobile computing device 1006C such as a mobile telephone, a smart phone, or other mobile computing device; a server computer 1006D; and/or other devices 1006N. It should be understood that any number of clients 1006 can communicate with the computing environment 1002.

In various examples, the computing environment 1002 includes servers 1008, data storage 1010, and one or more network interfaces 1012. The servers 1008 can host various services, virtual machines, portals, and/or other resources. In the illustrated configuration, the servers 1008 host virtual machines 1014, Web portals 1016, mailbox services 1018, storage services 1020, and/or, social networking services 1022. As shown in FIG. 10 the servers 1008 also can host other services, applications, portals, and/or other resources (“other resources”) 1024.

As mentioned above, the computing environment 1002 can include the data storage 1010. According to various implementations, the functionality of the data storage 1010 is provided by one or more databases operating on, or in communication with, the network 1004. The functionality of the data storage 1010 also can be provided by one or more servers configured to host data for the computing environment 1002. The data storage 1010 can include, host, or provide one or more real or virtual datastores 1026A-826N (hereinafter referred to collectively and/or generically as “datastores 1026”). The datastores 1026 are configured to host data used or created by the servers 1008 and/or other data. That is, the datastores 1026 also can host or store web page documents, word documents, presentation documents, data structures, algorithms for execution by a recommendation engine, and/or other data utilized by any application program. Aspects of the datastores 1026 may be associated with a service for storing files.

The computing environment 1002 can communicate with, or be accessed by, the network interfaces 1012. The network interfaces 1012 can include various types of network hardware and software for supporting communications between two or more computing devices including, but not limited to, the computing devices and the servers. It should be appreciated that the network interfaces 1012 also may be utilized to connect to other types of networks and/or computer systems.

It should be understood that the distributed computing environment 1000 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1000 provides the software functionality described herein as a service to the computing devices. It should be understood that the computing devices can include real or virtual machines including, but not limited to, server computers, web servers, personal computers, mobile computing devices, smart phones, and/or other devices. As such, various configurations of the concepts and technologies disclosed herein enable any device configured to access the distributed computing environment 1000 to utilize the functionality described herein for providing the techniques disclosed herein, among other aspects.

The present disclosure is supplemented by the following example clauses:

Example 1: A method comprising: receiving structured text; tokenizing the structured text into a plurality of tokens; determining embedding vectors for the plurality of tokens; augmenting the embedding vectors with location vectors that represent locations of the plurality of tokens within the structured text; computing attention weights for pairs of the plurality of tokens using a self-attention mechanism; computing a structure-aware attention weight for a pair of the plurality of tokens based on the computed attention weights; and using the structure-aware attention weight to compute a hidden representation of an individual input token.

Example 2: The method of example 1, further comprising: augmenting the embedding vectors with metadata vectors that indicate a type of metadata associated with individual tokens.

Example 3: The method of example 2, wherein the metadata vectors indicate that a token is a key of a key-value pair, a value of a key-value pair, a keyword, a column name, or a data type.

Example 4: The method of example 1, wherein the structured text comprises hierarchical text.

Example 5: The method of example 1, wherein the structured text comprises a data table, the method further comprising: generating a hierarchical representation of the data-table by converting a row of the data table to an entry in the hierarchical representation, wherein the row of the data table comprises at plurality of values, and wherein the entry in the hierarchical representation comprises key-value pairs that represent the plurality of values.

Example 6: The method of example 1, wherein the structured text comprises flat text, and wherein the flat text is converted to hierarchical text that includes a single branch of tokens.

Example 7: The method of example 1, wherein the structured text comprises hierarchical text, and wherein the structure-aware attention weight is computed based on attention weights of tokens along branches from the root of the hierarchical text to the pair of the plurality of tokens.

Example 8: The method of example 7, further comprising: identifying a cartesian product of tokens in a first of the branches from the root of the hierarchical text and tokens in a second of the branches from the root of the hierarchical text, wherein the structure-aware attention weight is computed by averaging attention weights of pairs of tokens in the cartesian product.

Example 9: A computer-readable storage medium having computer-executable instructions stored thereupon that, when executed by a processing system, cause the processing system to: receive structured text; tokenize the structured text into a plurality of tokens; determine embedding vectors for the plurality of tokens; augment the embedding vectors with location vectors that represent locations of the plurality of tokens within the structured text; augment the embedding vectors with metadata vectors that indicate a type of metadata associated with individual tokens; compute attention weights for pairs of the plurality of tokens using a self-attention mechanism; compute a structure-aware attention weight for a pair of the plurality of tokens based on the computed attention weights; and use the structure-aware attention weight to compute a hidden representation of an individual input token.

Example 10: The computer-readable storage medium of example 9, wherein the structured text comprises hierarchical text, and wherein the embedding vectors were trained in part based on structured masked-language modeling.

Example 11: The computer-readable storage medium of example 10, wherein structured masked-language modeling masks tokens based on structure information derived from the hierarchical text.

Example 12: The computer-readable storage medium of example 9, wherein location vectors encode a series of offsets from tokens in the hierarchy.

Example 13: The computer-readable storage medium of example 9, wherein metadata vectors encode a series of indications whether a token is a key of a key-value pair or a value of a key-value pair.

Example 14: A processing system, comprising: a processor; and a computer-readable storage medium having computer-executable instructions stored thereupon that, when executed by the processor, cause the processing system to: receive structured text; tokenize the structured text into a plurality of tokens; determine embedding vectors for the plurality of tokens; augment the embedding vectors with location vectors that represent locations of the plurality of tokens within the structured text; augment the embedding vectors with metadata vectors that indicate a type of metadata associated with individual tokens; compute attention weights for pairs of the plurality of tokens using a self-attention mechanism; compute a matrix of structure-aware attention weights for a every pair of the plurality of tokens based on the computed attention weights; and use the matrix of structure-aware attention weights to compute a hidden representation of an individual input token.

Example 15: The processing system of example 14, wherein the location vectors and metadata vectors are added to the token embeddings with position vectors that represent locations within the plurality of tokens.

Example 16: The processing system of example 14, wherein the hidden representation is generated by performing a matrix multiplication of the matrix of structure-aware attention weights and a value vector.

Example 17: The processing system of example 16, wherein the value vector is trained using a feed-forward network, and wherein the input of the feed-forward network is token embeddings that have been augmented to include location information.

Example 18: The processing system of example 14, wherein the hidden representation is used to train a machine learning model.

Example 19: The processing system of example 18, wherein the machine learning model is trained with different types of structured text.

Example 20: The processing system of example 14, wherein attention weights are computed by a self-attention mechanism of a transformer architecture, and wherein the structure-aware weights are computed by a structure-aware attention mechanism that consumes attention weights computed by the self-attention mechanism.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving structured text;
tokenizing the structured text into a plurality of tokens;
determining embedding vectors for the plurality of tokens;
augmenting the embedding vectors with location vectors that represent locations of the plurality of tokens within the structured text;
computing attention weights for pairs of the plurality of tokens using a self-attention mechanism;
computing a structure-aware attention weight for a pair of the plurality of tokens based on the computed attention weights; and
using the structure-aware attention weight to compute a hidden representation of an individual input token.

2. The method of claim 1, further comprising:
augmenting the embedding vectors with metadata vectors that indicate a type of metadata associated with individual tokens.

3. The method of claim 2, wherein the metadata vectors indicate that a token is a key of a key-value pair, a value of a key-value pair, a keyword, a column name, or a data type.

4. The method of claim 1, wherein the structured text comprises hierarchical text.

5. The method of claim 1, wherein the structured text comprises a data table, the method further comprising:
generating a hierarchical representation of the data-table by converting a row of the data table to an entry in the hierarchical representation, wherein the row of the data table comprises at plurality of values, and wherein the entry in the hierarchical representation comprises key-value pairs that represent the plurality of values.

6. The method of claim 1, wherein the structured text comprises flat text, and wherein the flat text is converted to hierarchical text that includes a single branch of tokens.

7. The method of claim 1, wherein the structured text comprises hierarchical text, and wherein the structure-aware attention weight is computed based on attention weights of tokens along branches from the root of the hierarchical text to the pair of the plurality of tokens.

8. The method of claim 7, further comprising:
identifying a cartesian product of tokens in a first of the branches from the root of the hierarchical text and tokens in a second of the branches from the root of the hierarchical text, wherein the structure-aware attention weight is computed by averaging attention weights of pairs of tokens in the cartesian product.

9. A computer-readable storage medium having computer-executable instructions stored thereupon that, when executed by a processing system, cause the processing system to:
receive structured text;
tokenize the structured text into a plurality of tokens;
determine embedding vectors for the plurality of tokens;
augment the embedding vectors with location vectors that represent locations of the plurality of tokens within the structured text;
augment the embedding vectors with metadata vectors that indicate a type of metadata associated with individual tokens;
compute attention weights for pairs of the plurality of tokens using a self-attention mechanism;
compute a structure-aware attention weight for a pair of the plurality of tokens based on the computed attention weights; and
use the structure-aware attention weight to compute a hidden representation of an individual input token.

10. The computer-readable storage medium of claim 9, wherein the structured text comprises hierarchical text, and wherein the embedding vectors were trained in part based on structured masked-language modeling.

11. The computer-readable storage medium of claim 10, wherein structured masked-language modeling masks tokens based on structure information derived from the hierarchical text.

12. The computer-readable storage medium of claim 9, wherein location vectors encode a series of offsets from tokens in the hierarchy.

13. The computer-readable storage medium of claim 9, wherein metadata vectors encode a series of indications whether a token is a key of a key-value pair or a value of a key-value pair.

14. A processing system, comprising:
a processor; and
a computer-readable storage medium having computer-executable instructions stored thereupon that, when executed by the processor, cause the processing system to:
receive structured text;
tokenize the structured text into a plurality of tokens;
determine embedding vectors for the plurality of tokens;
augment the embedding vectors with location vectors that represent locations of the plurality of tokens within the structured text;
augment the embedding vectors with metadata vectors that indicate a type of metadata associated with individual tokens;
compute attention weights for pairs of the plurality of tokens using a self-attention mechanism;
compute a matrix of structure-aware attention weights for a every pair of the plurality of tokens based on the computed attention weights; and
use the matrix of structure-aware attention weights to compute a hidden representation of an individual input token.

15. The processing system of claim 14, wherein the location vectors and metadata vectors are added to the token embeddings with position vectors that represent locations within the plurality of tokens.

16. The processing system of claim 14, wherein the hidden representation is generated by performing a matrix multiplication of the matrix of structure-aware attention weights and a value vector.

17. The processing system of claim 16, wherein the value vector is trained using a feed-forward network, and wherein the input of the feed-forward network is token embeddings that have been augmented to include location information.

18. The processing system of claim 14, wherein the hidden representation is used to train a machine learning model.

19. The processing system of claim 18, wherein the machine learning model is trained with different types of structured text.

20. The processing system of claim 14, wherein attention weights are computed by a self-attention mechanism of a transformer architecture, and wherein the structure-aware weights are computed by a structure-aware attention mechanism that consumes attention weights computed by the self-attention mechanism.
